(19) United States
(12) Patent Application Publication
(10) Pub. No.: US 2009/0038076 A1
(43) Pub. Date: Feb. 12, 2009

(54) FLEXIBLE LITTER

(76) Inventor: John P. Giduck, Bailey, CO (US)

Correspondence Address: DORR, CARSON & BIRNEY, P.C.;ONE CHERRY CENTER, 501 SOUTH CHERRY STREET, SUITE 800, DENVER, CO, 80246, US

(21) Appl. No.: 11/836,542

(22) Filed: Aug. 9, 2007

(51) Int. Cl. A61G 1/013

(52) U.S. Cl. 5/627

(57) ABSTRACT

A flexible litter for emergency and non-emergency evacuations having a rectangular main section with side, head, and foot edge portions. In one embodiment, loop-shaped handgrips are attached to the head and foot edge portions and two sets of loop-shaped shoulder straps are attached to the sides of the main section. The loops of each set of shoulder straps extend away from the main section of the litter for a substantially greater distance than the loops of the handgrips and the loops of one set can be passed through a handgrip and looped over a carrier's shoulders like a backpack leaving the hands of the carrier free for other tasks. In other configurations, the loops can be placed directly over the rescuers' shoulders again leaving their hands free.

### BACKGROUND OF THE INVENTION

1. Field of the Invention

This invention relates to the field of flexible litters and more particularly to the field of flexible litters for emergency evacuations.

2. Discussion of the Background

Flexible litters are widely used to transport people in emergency and non-emergency situations. The vast majority of current litters are ones that are simply pulled or dragged along the ground or floor from one end by a handle or extension with the person strapped on the litter. In certain areas such as rough terrain or even in parts of building such as stairs, dragging a loaded litter can often be very difficult and awkward to do. It can also potentially further harm the person being transported as well as expose the rescuer or rescuers to injury.

Emergency evacuations such as from fires or in combat zones put great demands on the design of a litter. Such litters must not only be capable of being effectively and efficiently used to evacuate the injured person but also must permit the rescuer or rescuers to protect themselves and others in doing so. In fire situations, for example, it is highly desirable that the fireman's hands be left free to continue to fight the fire or perform other tasks such as opening doors, gripping handrails, or removing obstacles. In combat situations, it is equally or even more important for the rescuer or rescuers to have their hands free to continue to hold and discharge their rifles or other weapons to protect the injured person as well as themselves. Current litter designs do not effectively and efficiently offer such advantages.

With this and other problems in mind, the present invention was developed. In it, handgrips and shoulder straps are provided on the flexible litter that permit a number of carrying configurations to be used to evacuate the injured person. In the preferred configurations, the litter can be dragged on the ground by one person or lifted off the ground by two or more people yet still leave the hands of the rescuer or rescuers free to perform other tasks.

### SUMMARY OF THE INVENTION

This invention involves a flexible litter for emergency and non-emergency evacuations. The litter includes a rectangular main section with side, head, and foot edge portions. The side portions are spaced from each other and extend along a longitudinal axis with the head and foot edge portions extending transversely of the longitudinal axis between the side portions. In one embodiment, loop-shaped handgrips are attached to the head and foot edge portions and two sets of loop-shaped shoulder straps are attached to the sides of the main section. The loops of the shoulder straps extend away from the main section of the litter for a substantially greater distance than the loops of the handgrips.

In one carrying configuration, the side loops of one set of shoulder straps can be passed through a handgrip on the end of the litter and looped over a carrier's shoulders like a backpack. The rescuer can then drag the loaded litter leaving his hands free to perform other tasks. In another configuration, the shoulder straps of the other set can be passed through the other handgrip and looped over a second carrier's shoulders. The litter can then be lifted between the two carriers, still leaving their hand free to do other tasks. In a further configuration, the litter can be carried by four rescuers by looping a shoulder strap over each carrier, again leaving their hands free.

The main section of the litter can also be provided with foot and head pouches to receive the injured person's feet and head. The foot pouch in particular is provided with an axially extending strap to secure the person's feet in place. With the foot strap and other body straps secured, the litter and injured person can then be safely lowered even vertically as from a helicopter.

A second embodiment of the litter employs three sets of loop-shaped shoulder straps on the sides of the litter and adds handgrips within each loop. This embodiment can be configured for carrying as in the first embodiment and can additionally be configured to be carried by six rescuers with the loops over their shoulders and hands free. The side handgrips could also be gripped if desired to carry the litter.

Both embodiments of the present invention can further be provided with a storage pouch on the lower or underside of the main section. During rescues, the storage pouch is held flush against the underneath side by a strap and buckles. In between evacuations, the storage pouch can be unbuckled and inverted or turned inside out and the litter rolled or otherwise collapsed into it.

### BRIEF DESCRIPTION OF THE DRAWINGS

FIG. 1 is a top plan view of the flexible litter of the present invention shown with an injured person strapped to it.

FIG. 2 is a top plan view of the litter without the person in it.

FIG. 3 is a bottom plan view of the litter.

FIGS. 4-8 sequentially illustrate how the loops of the forward set of shoulder straps can be passed through the front handgrip and looped over a rescuer's shoulder like a backpack (FIG. 8) leaving the rescuer's hands free for other tasks.

FIG. 9 shows how the loops of the rearward set of shoulder straps can be similarly passed through the rear handgrip and looped over the shoulders of a second rescuer leaving his hands free.

FIG. 10 illustrates the litter being dragged by gripping the front handgrip.

FIG. 11 shows another configuration in which the litter is carried by four rescuers with the loops of the shoulder straps over their shoulders leaving their hands free.

FIG. 12 illustrates the flexible litter of the present invention in use to safely lower an injured person in a vertical position as from a helicopter.

FIG. 13 illustrates a second embodiment of the litter in which there are three sets of shoulder straps with side handgrips positioned between the loops of the shoulder straps.

FIG. 14 shows the litter of FIG. 13 being carried by its side handgrips.

FIG. 15 is a bottom plan view of the litter of FIG. 13 showing the storage pouch.

FIGS. 16-18 sequentially illustrate how the storage pouch of FIG. 15 can be inverted or turned inside out and the litter rolled up or otherwise collapsed into it for convenient storage.

### DETAILED DESCRIPTION OF THE INVENTION

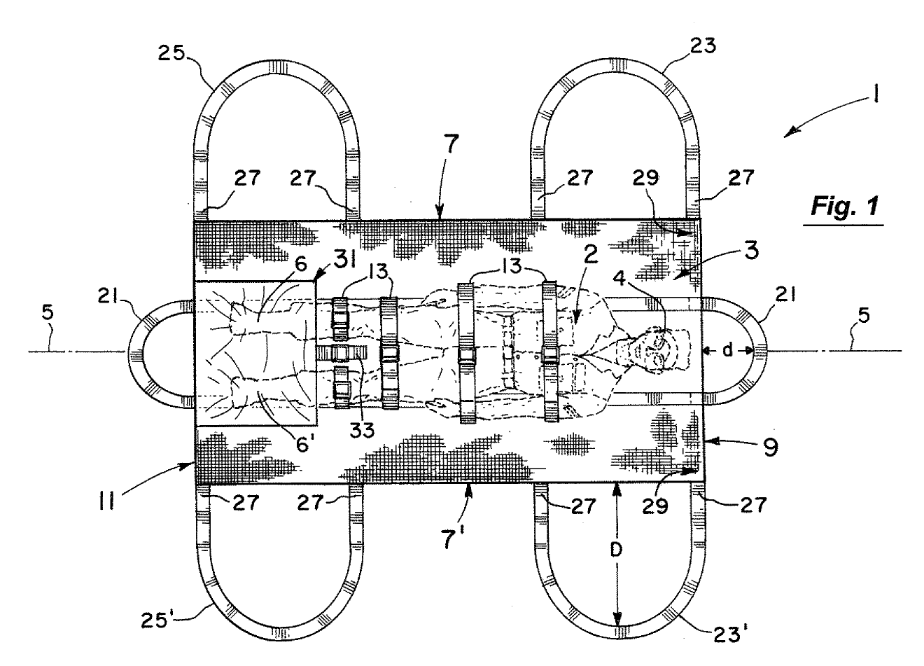

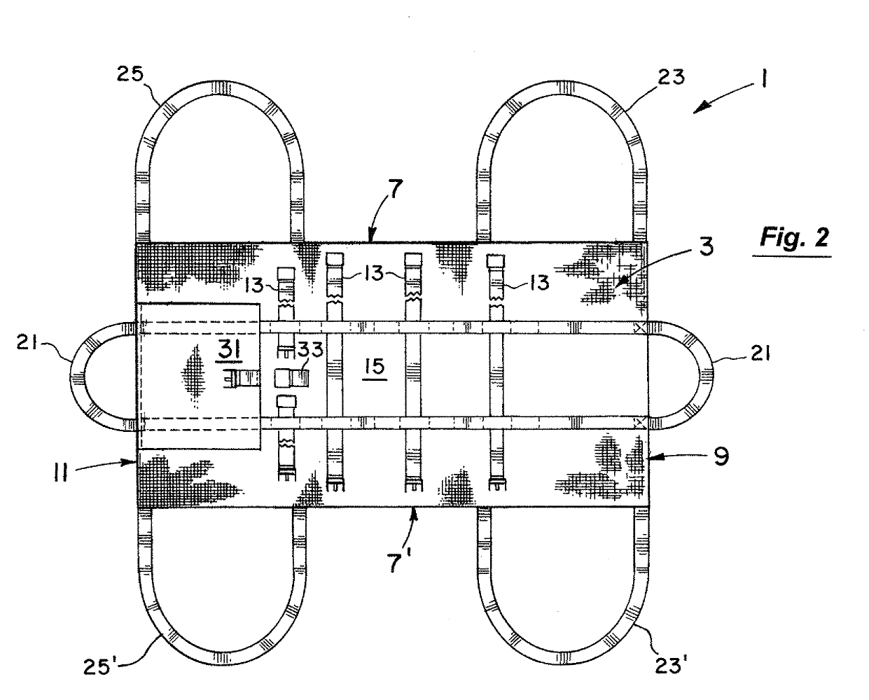

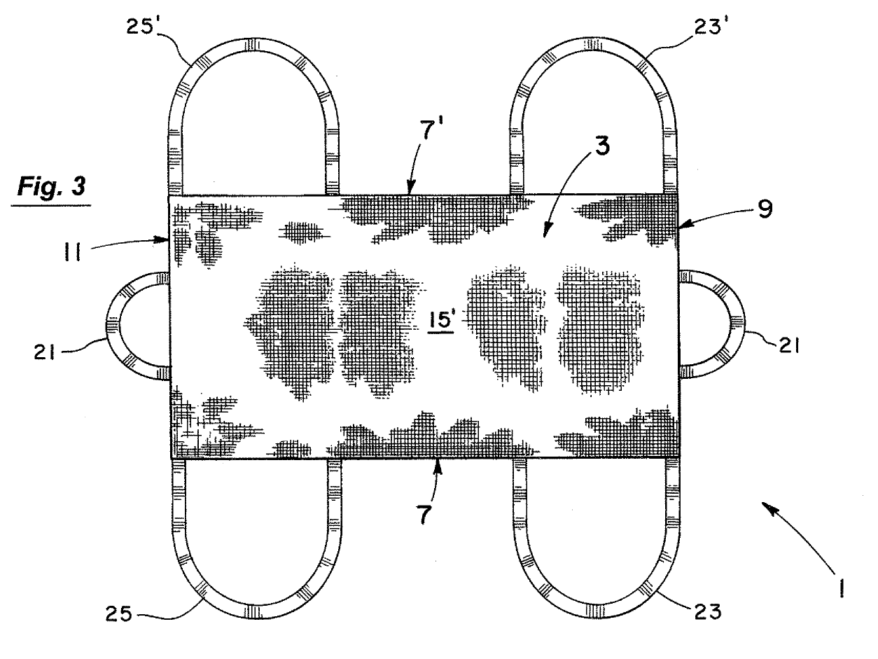

As shown in FIGS. 1-3, the flexible litter 1 of the present invention includes a substantially rectangular main section 3. The main section 3 (see FIG. 1) extends along the longitudinal axis 5 and has two side edge portions 7,7′ as well as head 9 and foot 11 end edge portions. The side edge portions 7,7′ as illustrated are spaced from each other and extend substantially parallel to the longitudinal axis 5. The spaced apart head and foot end edge portions 9 and 11 in turn extend substantially transversely of the axis 5 between the two side edge portions 7,7′ to form the rectangular shape of the main section 3. The body 2 of the person to be rescued or otherwise transported is receivable on the rectangular main section 3 between the side edge portions 7,7′ with the person's head 4 adjacent the head end edge portion 9 and his/her feet 6,6′ adjacent the foot end edge portion 11. The main section 3 of FIGS. 1-3 is dimensioned (e.g., 6.5 feet long or greater and 3 feet or more wide) to receive and support the person's entire body 2 with the body straps 13 (FIG. 1) on the upper side 15 of the main section 3 securely holding the person in place.

The flexible litter 1 of the embodiment of FIGS. 1-3 has at least one and preferably two handgrips 21 attached to the respective end edge portions 9,11. The handgrips 21 as shown are preferably loop-shaped, flat strips (e.g., 2 inches wide) and extend a relative short distance d (e.g., six to twelve inches) away from the main section 3 of the flexible litter 1. The handgrips 21 in this regard are dimensioned to receive and be capable of being gripped by the rescuer's or carrier's hand. The flexible litter 1 of this embodiment additionally includes at least one set and preferably two sets of loop-shaped shoulder straps 23,23′ and 25,25′. Each shoulder strap is substantially U-shaped (e.g., curved or straight sides) with the tips 27 of the respective U-shapes (FIG. 1) spaced from each other (e.g., twenty inches) and attached (e.g., sewn) to the main section 3 of the flexible litter 1. The tips of the U-shaped handgrips 21 are similarly spaced apart (e.g., twelve inches) and attached to the main section 3 as illustrated,

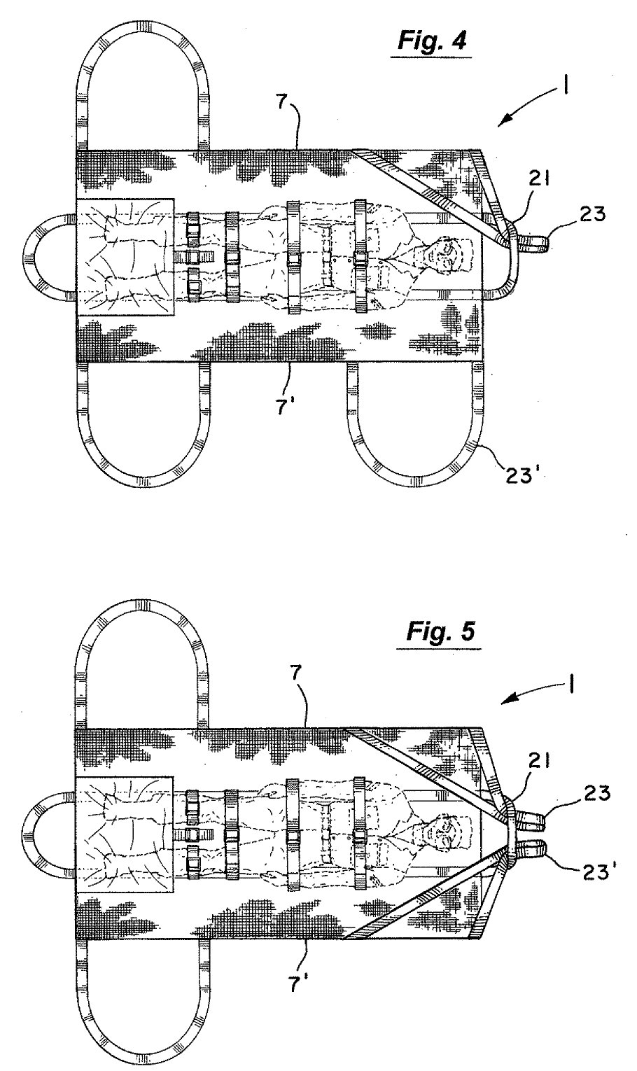

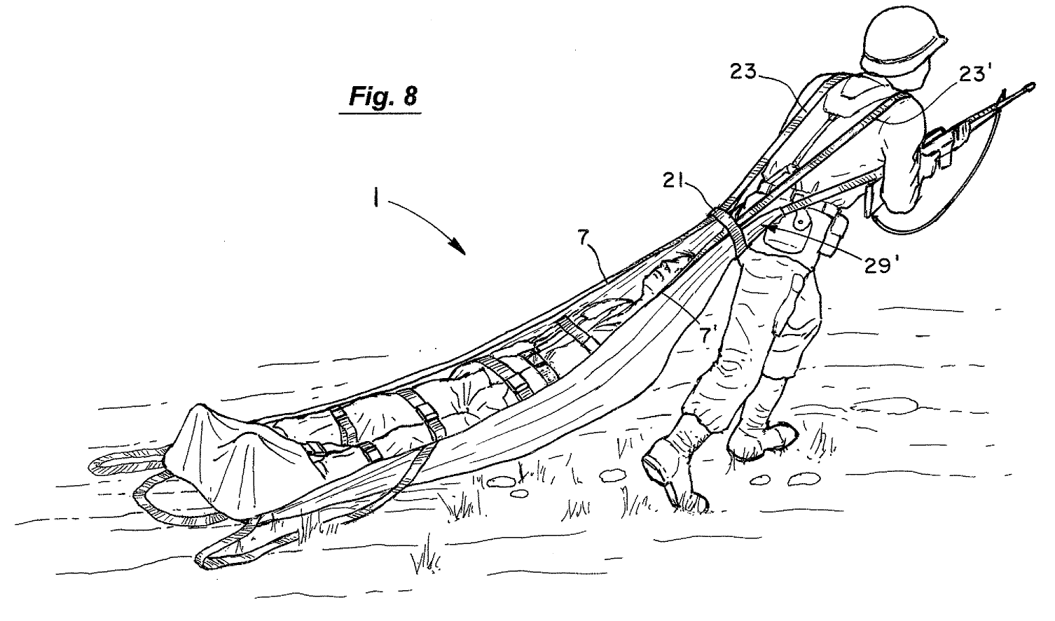

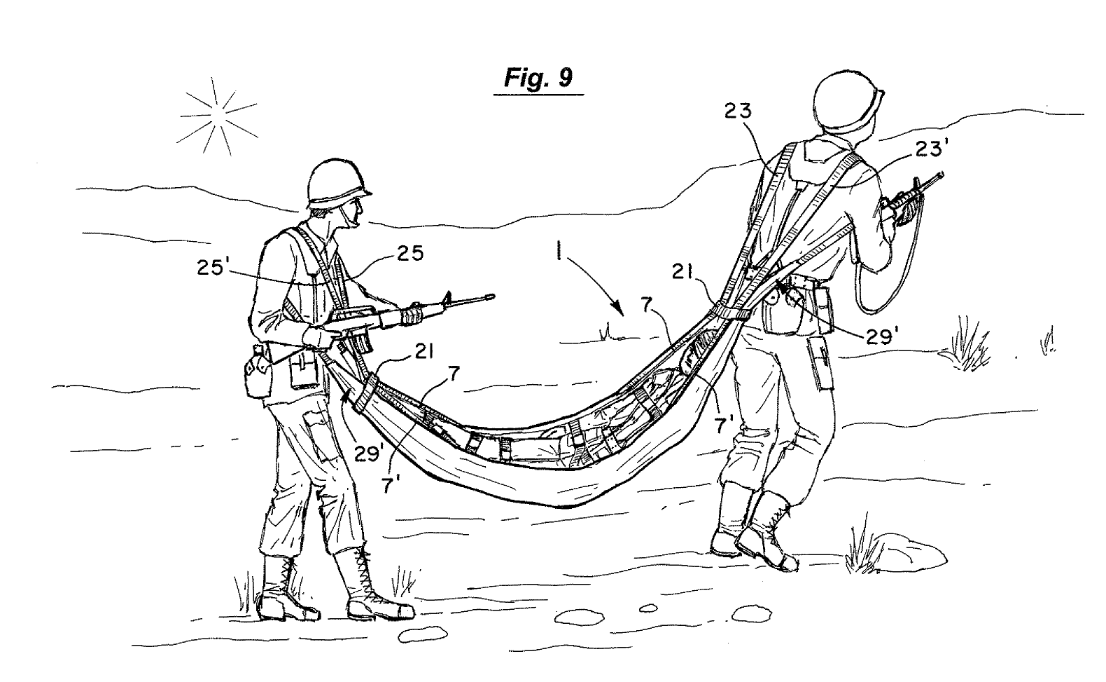

The loops of the shoulder straps 23,23′ and 25,25′ of FIG. 1 preferably extend away from the main section 3 of the flexible litter 1 for a distance D (e.g., twenty to twenty-four inches) substantially greater than the distance d the handgrips 21 extend away from the main section 3. In this manner, each set of shoulder straps (e.g., 23,23′ in FIGS. 4-8) can be passed substantially through a handgrip 21 and looped over a single rescuer's or carrier's shoulders (FIG. 8) like a backpack. This leaves the rescuer's hands free to perform any number of tasks including holding a rifle as in FIG. 8 in a combat situation or carrying fight fighting equipment or simply opening doors, gripping handrails, and removing obstacles in non-combat evacuations. This configuration also aids the stability of the litter against twisting or rolling about its longitudinal axis. The rear set of shoulder straps 25,25′ (see FIG. 9) can similarly be passed through the rear handgrip 21 and looped over a second rescuer's or carrier's shoulders. In both cases as shown, the rescuers' hands are still left free to perform other tasks.

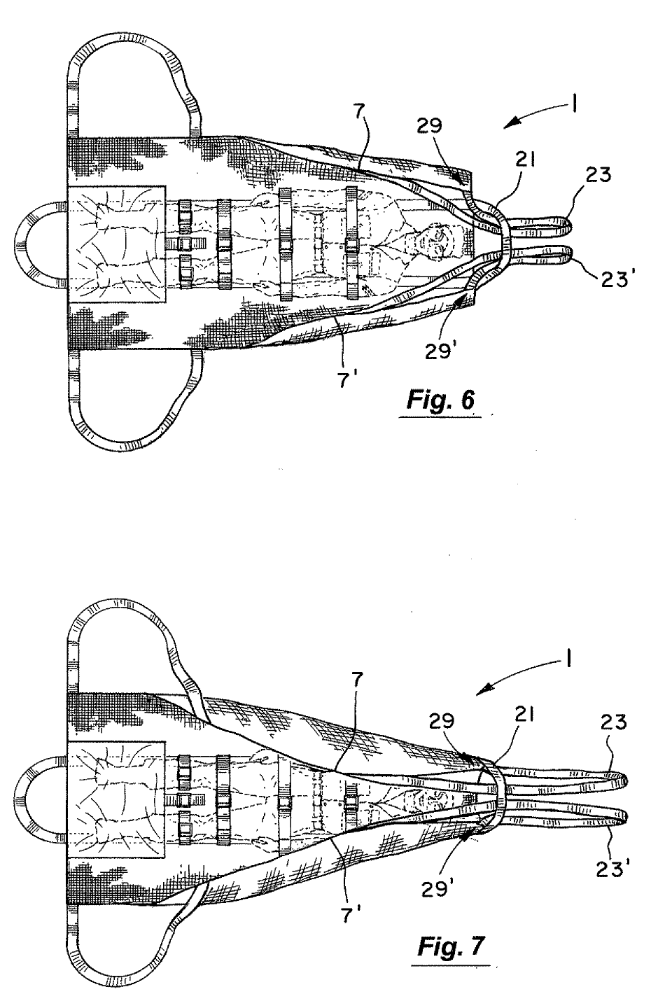

An additional safety feature of the flexible litter 1 is that the side edge portions 7,7′ adjacent the corner sections 29,29′ (where the side 7,7′ and head 9 edge portions meet in FIG. 1) curl inwardly toward each other as the shoulder straps 23,23′ are passed through the forward handgrip 21 (see FIGS. 6-8). In doing so, the curled side edge portions 7,7′ in FIGS. 6-8 essentially cradle the injured person's upper body (FIG. 8) or upper and lower body as in FIG. 9 helping to further protect and retain the injured person in the flexible litter 1. In this regard as shown in FIGS. 8 and 9, the corner sections 29,29′ preferably pass through the handgrips 21 in these carrying configurations to enhance and maintain this curling, which also aids in the stability of the litter against twisting or rolling about its longitudinal axis.

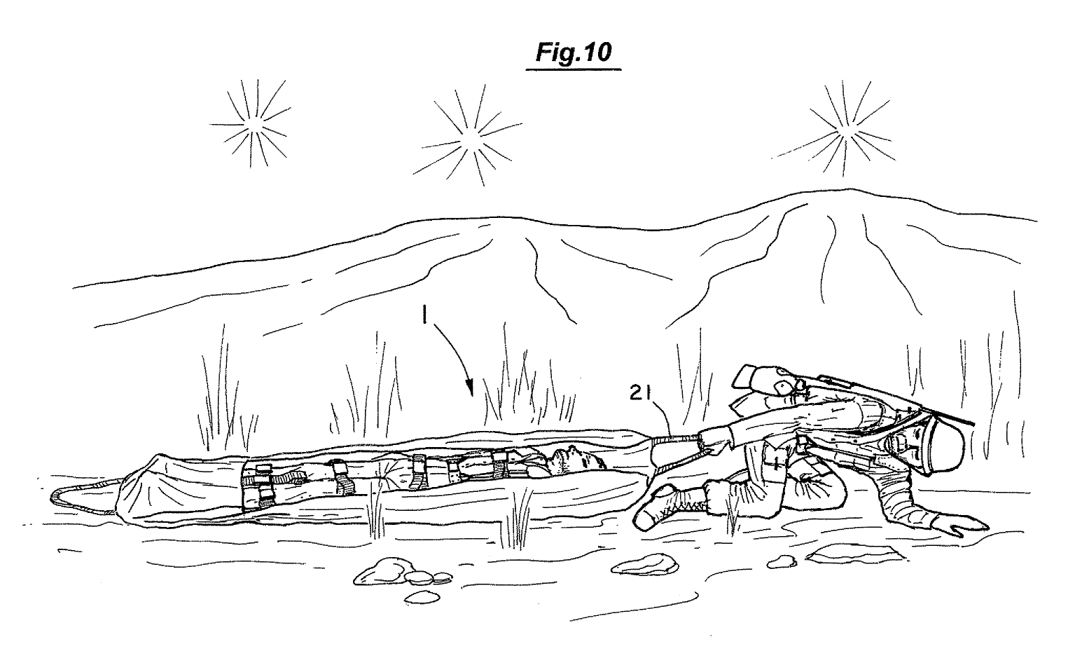

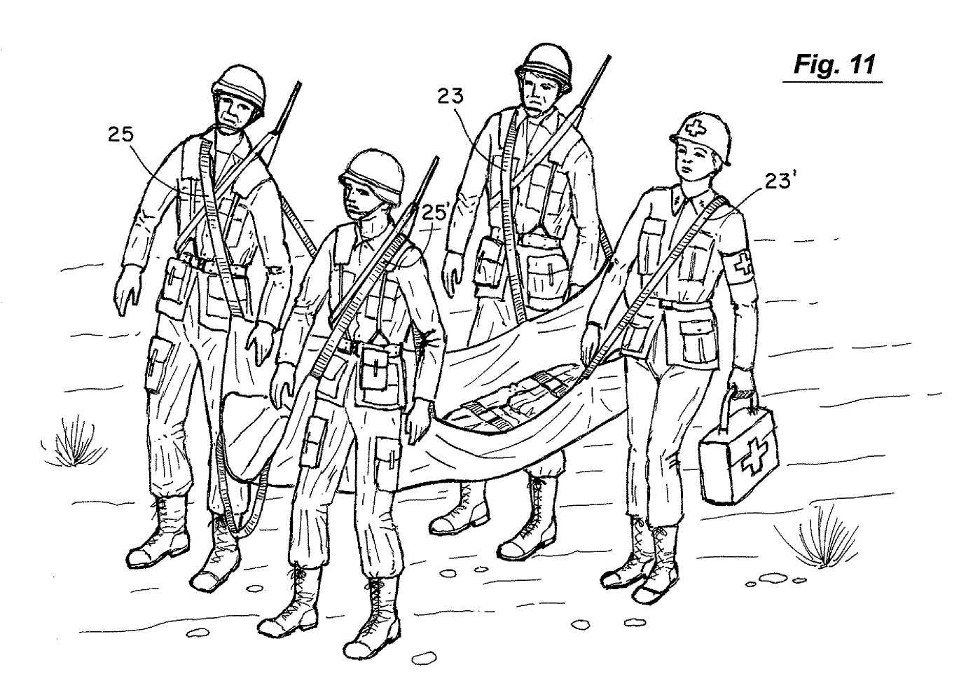

The handgrips 21 on either end edge portion can also be used to simply drag the flexible litter 1 as in FIG. 10. In the configuration of FIG. 11, the shoulder straps 23,23′ and 25,25′ are looped over the shoulders of four rescuers. In this carrying position, the rescuers' hands remains free for other tasks which can be of critical importance in combat and other emergency evacuations.

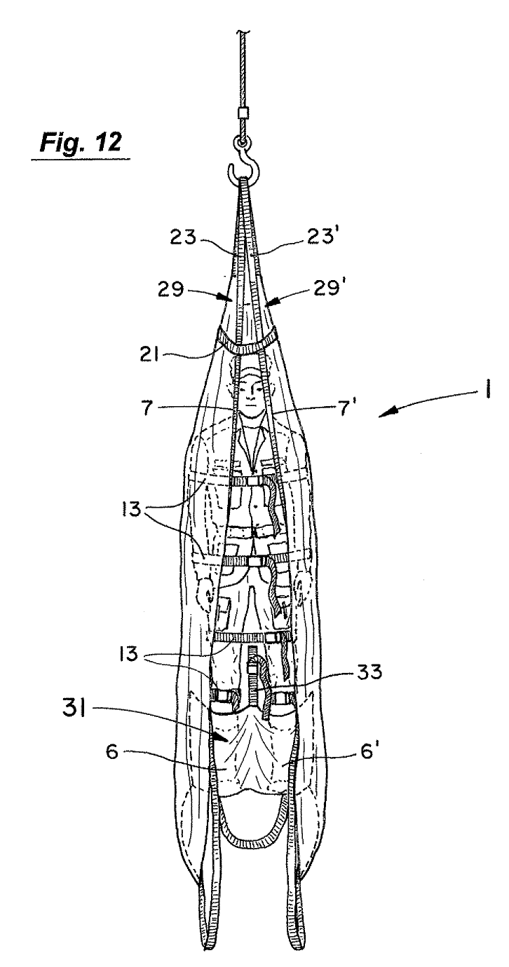

Another feature of the flexible litter 1 that adds versatility and safety to it is the foot pouch 31 of FIG. 1. The pouch 31 (e.g., 18×22 inches) is attached to the main section 3 of the flexible litter 1 and receives the person's feet 6,6′. An axially extending strap 33 between the pouch 31 and main section 3 then helps secure the person's feet 6,6′ in place. With the person's feet 6,6′ secured in the pouch 31 and the other straps 13 in place, the flexible litter 1 with the person body 2 secured to it can be safely lowered even vertically (e.g., from a helicopter) as in FIG. 12. Like the configuration of FIG. 8, the corner sections 29,29′ and immediately adjacent side edge portions 7,7′ are curled toward each other substantially over the injured person's upper body to help protect and maintain the person in the flexible litter 1.

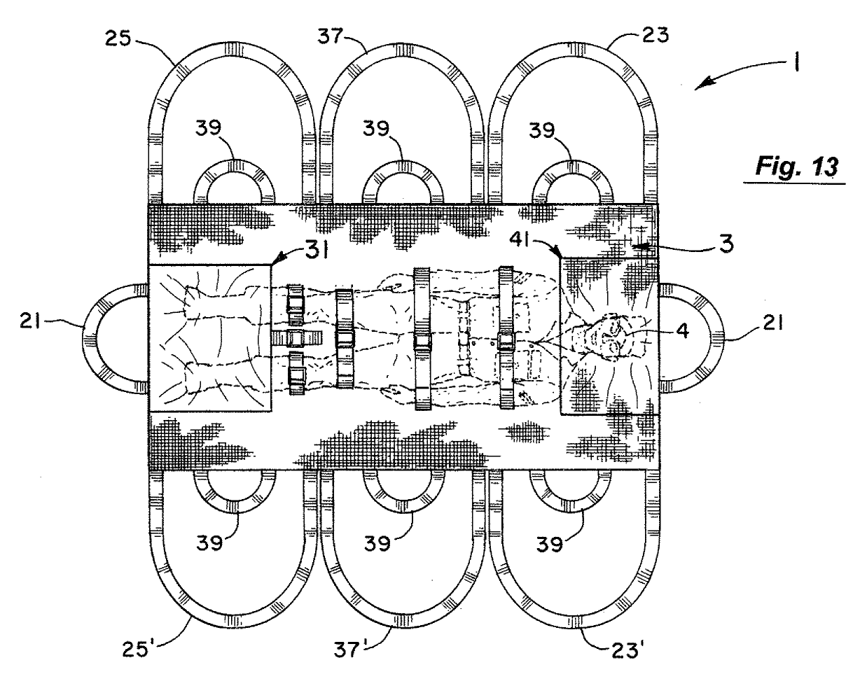

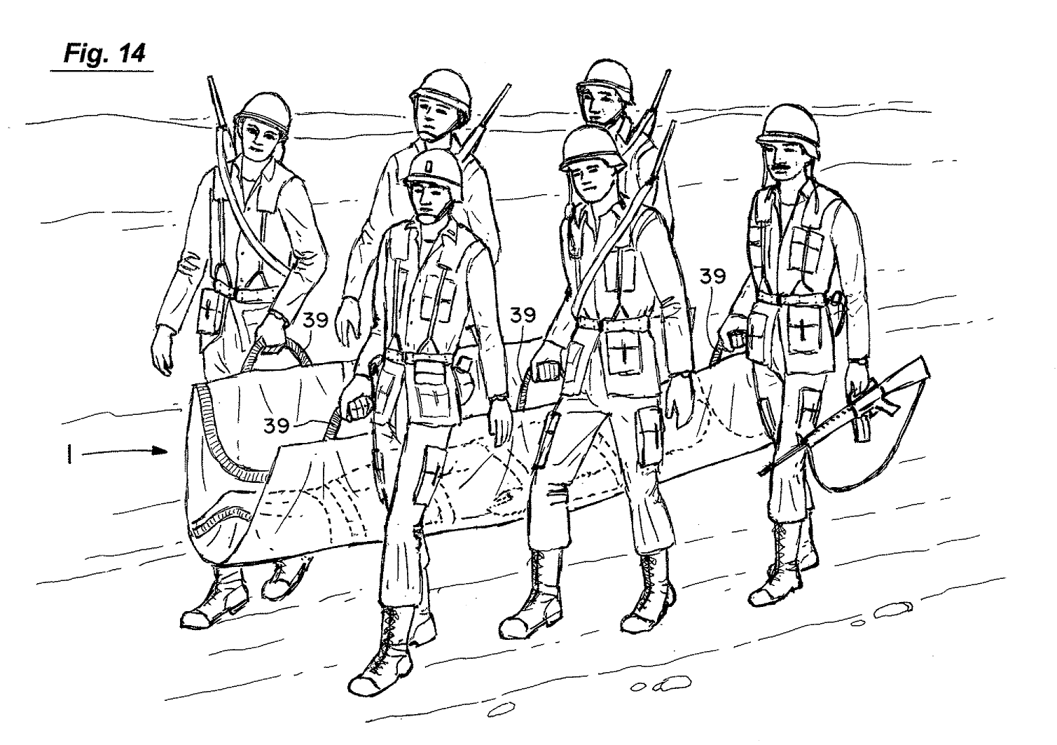

FIG. 13 illustrates another embodiment of the flexible litter 1 in which there are three sets of shoulder straps 23,23′; 25,25′; and 37,37′. Additionally, side handgrips 39 are provided within each loop of the shoulder straps. The flexible litter 1 can then be configured and used as in FIGS. 8-12 or the flexible litter 1 can be lifted by the side handgrips 39 as in FIG. 14. The embodiment of FIGS. 1-12 could be similarly provided with side handgrips if desired. The embodiment of FIG. 13 further illustrates the addition of a head pouch 41 to receive and cover the injured person's head 4.

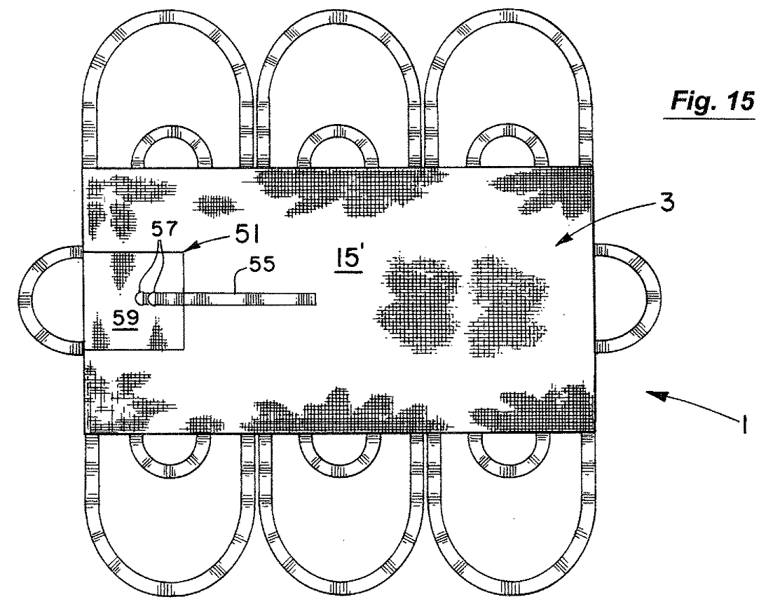

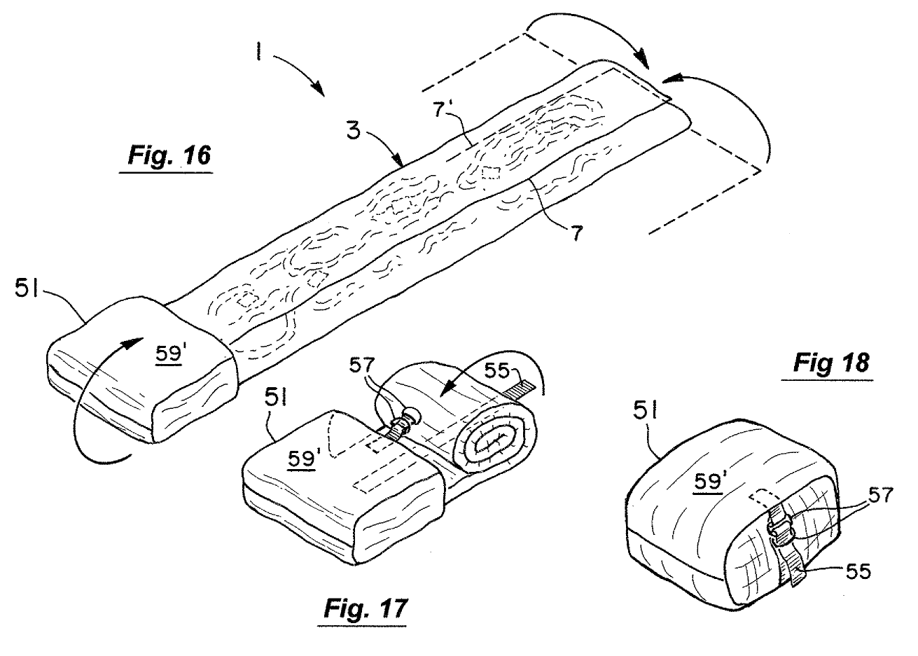

The embodiment of FIG. 13 as well as that of FIG. 1 could also be provided with a storage pouch 51 (FIG. 15) on the lower or underside 15′ of the main section 3. In normal use of the flexible litter 1, the strap/buckles 55,57 for the storage pouch 51 hold the open side 59 (e.g., 16×18 inches) flush with the underneath side 15′ of the main section 3. However, in storage use and with the main section 3 facing up and the strap 55 unbuckled, the storage pouch 51 (FIG. 16) is first inverted or turned inside out so that the inner side 59′ of the side 59 in FIG. 15 is now facing outwardly. The side edge portions 7,7′ can then be folded inwardly toward or over each other as in FIG. 16. Thereafter, the flexible litter 1 (e.g., nylon, vinyl, canvas, or other fabric-like material) can be rolled up as in FIG. 17 or otherwise bundled or collapsed into the storage pouch 51 and secured in the pouch 51 by the strap/buckles 55,57 as in FIG. 18.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

1. A flexible litter for transporting a body, said flexible litter including:
a substantially rectangular main section extending along a first axis and having two side edge portions spaced from each other and extending substantially parallel to the first axis, said main section further including head and foot end edge portions spaced from each other and extending substantially transversely of the first axis between said side edge portions, the body to be transported being receivable on the rectangular main section between said side edge portions with the head of the body adjacent the head end edge portion thereof and the feet of the body adjacent the foot end edge portion thereof,
said flexible litter further including at least one, loop-shaped handgrip attached to one of the end edge portions, the loop of said handgrip extending a relatively short, first distance away from the main section of the flexible litter to receive and be capable of being gripped by a carrier's hand, said flexible litter additionally including at least a first set of two, loop-shaped shoulder straps, each shoulder strap being respectively attached adjacent respective side edge portions of the main section of the flexible litter and adjacent the one end edge portion and handgrip attached thereto wherein the loop of each shoulder strap extends a second distance away from the main section of the flexible litter, said second distance being substantially greater than said first distance of said handgrip wherein each shoulder strap can be substantially passed through the loop of the handgrip and looped over a carrier's shoulder.

2. The flexible litter of claim 1 wherein said second distance of each shoulder strap is at least two times greater than the first distance of said handgrip.

3. The flexible litter of claim 1 wherein said second distance of each shoulder strap is at least two to three times greater than the first distance of said handgrip.

4. The flexible litter of claim 1 wherein said first distance is less than about twelve inches.

5. The flexible litter of claim 1 wherein said second distance is at least about twenty inches.

6. The flexible litter of claim 1 wherein the loop of at least one of the shoulder straps is substantially U-shaped with the tips of the U-shape spaced from each other and attached to the main section of the flexible litter.

7. The flexible litter of claim 1 wherein the loops of the handgrip and shoulder straps are substantially U-shaped with the tips of the respective U-shapes spaced from each other and attached to the main section of the flexible litter.

8. The flexible litter of claim 7 wherein the one end edge portion with the handgrip attached thereto meets each side edge portion to form respective corner sections of the main section and each shoulder strap of the first set is attached adjacent a respective one of said corner sections.

9. The flexible litter of claim 8 wherein the shoulder straps of the first set can be substantially passed through the loop of the handgrip with the respective corner sections attached to said shoulder straps additionally being passed through the loop of said handgrip.

10. The flexible litter of claim 7 wherein at least one tip of each U-shaped loop of said shoulder straps is attached to a respective side edge portion of the main section of the flexible litter.

11. The flexible litter of claim 10 wherein both tips of each U-shaped loop of said shoulder straps are attached to respective side edge portions of the main section of the flexible litter.

12. The flexible litter of claim 1 wherein the one end edge portion with the handgrip attached thereto is the head end edge portion.

13. The flexible litter of claim 1 wherein the loops of the handgrip and shoulder straps are substantially U-shaped with the tips of the respective U-shapes spaced from each other and attached to the main section of the flexible litter and the side edge portions adjacent said corner sections are curled inwardly toward each other with the shoulder straps substantially passed through the loop of the handgrip.

14. The flexible litter of claim 1 further including a second, loop-shaped handgrip attached to the other end edge portion of the main section of the flexible litter, the loop of the second handgrip extending a relatively short distance away from the main section of the flexible litter to receive and be capable of being gripped by a carrier's hand, said flexible litter additionally including a second set of two, loop-shaped shoulder straps, each shoulder strap being respectively attached to respective side edge portions of the main section of the flexible litter adjacent the other end edge portion and second handgrip attached thereto wherein each shoulder strap extends a distance away from the main section of the flexible litter substantially greater than the distance the second handgrip extends away from the main section wherein each shoulder strap of the second set can be passed through the loop of the second handgrip and looped over a carrier's shoulder.

15. The flexible litter of claim 14 wherein said first and second sets of shoulder straps are substantially identical in shape and size.

16. The flexible litter of claim 14 wherein said first and second handgrips form a first set and said flexible litter further includes a second and third set of loop-shaped handgrips respectively attached to the respective side edge portions within the respective loops of said first and second sets of shoulder straps.

17. The flexible litter of claim 14 further including a third set of two, loop-shaped shoulder straps, each shoulder strap of the third set being respectively attached to respective side edge portions of the main section of the flexible litter to extend between the respective first and second sets of shoulder straps.

18. The flexible litter of claim 17 wherein said first and second handgrips form a first set and said flexible litter further includes second, third, and fourth sets of loop-shaped handgrips respectively attached to the respective side edge portions within the respective loops of said first, second, and third sets of shoulder straps.

19. The flexible litter of claim 1 further including a pouch attached to said main section of the flexible litter adjacent said foot end edge portion to receive the feet of the body being transported.

20. The flexible litter of claim 19 further including a pouch attached to said main section adjacent the head end edge portion to receive the head of the body being transported.

21. The flexible litter of claim 1 further including a pouch attached to said main section adjacent the head end edge portion to receive the head of the body being transported.

22. The flexible litter of claim 1 wherein the main section has upper and lower sides, said upper side including body straps attached thereto to secure the body being transported to the main section.

23. The flexible litter of claim 22 further including a storage pouch attached to the lower side of the main section wherein said main section, handgrip, shoulder straps, and body straps can be collapsed and stored in said storage pouch.

24. A method for manipulating a flexible litter for transporting a body, said method including the steps of:
(a) providing a flexible litter with a substantially rectangular main section extending along a first axis and having two side edge portions spaced from each other and extending substantially parallel to the first axis, the main section further including head and foot end edge portions spaced from each other and extending substantially transversely of the first axis between said side edge portions, the flexible litter further including at least one, loop-shaped handgrip attached to one of the end edge portions, the loop of said handgrip extending a relatively short, first distance away from the main section of the flexible litter to receive and be capable of being gripped by a carrier's hand, said flexible litter additionally including at least a first set of two, loop-shaped shoulder straps, each shoulder strap being respectively attached adjacent respective side edge portions of the main section of the flexible litter and adjacent the one end edge portion and handgrip attached thereto wherein the loop of each shoulder strap extends a second distance away from the main section of the flexible litter, said second distance being substantially greater than said first distance of said handgrip,
(b) passing each shoulder strap substantially through the loop of the handgrip, and
(c) looping each shoulder strap over a carrier's shoulder.

25. The method of claim 24 wherein the one end edge portion with the handgrip attached thereto meets each side edge portion to form respective corner sections and step (b) includes the further limitation of passing the corner sections through the loop of the handgrip.

26. The method of claim 24 wherein step (a) includes the further limitation of providing a second loop-shaped handgrip attached to the other end edge portion and substantially identical to the first mentioned handgrip and providing a second set of loop-shaped shoulder straps attached to the side edge portions and substantially identical to said first set and steps (b) and (c) include the further limitations of passing each shoulder strap of the second set substantially through the loop of the second handgrip and looping each shoulder strap of the second set over a second carrier's shoulder.
